(19) United States
(12) Patent Application Publication
(10) Pub. No.: US 2004/0236940 A1
(43) Pub. Date: Nov. 25, 2004

(54) Contents supplying system, method and program

(75) Inventor: Ryosuke Asai, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 10/807,400

(22) Filed: Mar. 24, 2004

(30) Foreign Application Priority Data
Mar. 25, 2003 (JP) 2003-082810

(51) Int. Cl. H04L 9/00

(52) U.S. Cl. 713/150

(57) ABSTRACT

Contents to be supplied to a user are divided into a core portion and one or more non-core portions, and an encryption process is applied to the core portion which is supplied to the user. Since the significant portion of the contents is used as the core portion, which is encrypted and transmitted, whole the contents can be substantially protected by the encryption process of only the core portion.

### BACKGROUND OF THE INVENTION

1. Field of the Invention

The present invention relates to a method of supplying various kinds of information including image information, sound information and the like.

2. Description of Related Art

It is performed that a user obtains image information, sound information and the various kinds of information (hereafter, they are called “contents”) from a server or a center apparatus (hereafter, they are called “server” together) by utilizing a communication channel or broadcasting. The typical contents are image and sound information of a movie, sound information of music, and a program and data of a computer, which are transmitted from the server device to a terminal device (client) of the user via a network and other channels (paths). It is noted that the typical path is the Internet.

In this case, by providing an information storing area to the client and storing the contents supplied from the server in the information storing area, the convenience in utilizing the information is improved. For example, in a case of the image and sound information, once the contents supplied from the server are stored in the information storing area of the client at one time, the user can reproduce and enjoy the contents whenever he or she wants.

However, once the contents are stored in the information storing area of the client, an evil practice, such as copy of the contents, is possible. It is comparatively easy to reproduce and copy the contents which are stored in the information storing area of the client. However, when the contents are the object of the copyright or fee-contents, problems happen. Though various kinds of countermeasures, e.g., supplying encrypted contents to the user, are taken in order to prevent the copy of the contents stored in the information storing area of the client, it cannot be denied that the illegal decryption of the encrypted contents is still possible. Also, if a complicated encryption process is executed to the contents so that decrypting the encrypted contents is difficult, it takes a long time for the legal user to decrypt the encrypted contents in reproducing the contents, though decrypting the encrypted contents is difficult. As a result, smooth reproduction by the legal user becomes difficult.

From this point of view, not a method of supplying whole the contents at one time, but a method of supplying a portion of the contents by dividing whole the contents is proposed. For example, there is proposed a method that perfect program data is restored by two processes, i.e., incomplete program data is broadcasted via digital broadcasting, and duplication control information is transmitted via the communication channel. This method is disclosed in Japanese Patent Application Laid-open under No. 2002-9716. There is also proposed a method that the user restores perfect image by receiving an imperfect file and a core file under condition that the imperfect file whose contents are partly deteriorated is transmitted before the core file which completes the imperfect file is separately transmitted. This method is disclosed in Japanese Patent Application Laid-open under No. 10-336625. Moreover, the proposal is also given of a system that the contents are transmitted with a certain portion thereof lacked, and necessary fee is charged to obtain the lacked portion. This method is disclosed in Japanese Patent Application Laid-open under No. 2002-16899.

As mentioned above, in the method of individually supplying the partly divided contents, effectiveness of such method is largely affected by the manner of making divided portions and the manner of supplying the portions.

### SUMMARY OF THE INVENTION

The present invention has been achieved in order to solve the above problems. It is an object of this invention to effectively prevent illegally copying and utilizing contents by providing appropriate manners of dividing and supplying the contents, in a method of dividing a portion of the contents and supplying the divided portions.

According to one aspect of the present invention, there is provided a contents supplying system including a server and a terminal device, wherein the server includes a unit which encrypts a second portion of contents by a predetermined method and transmits an encrypted second portion of the contents to the terminal device in response to a request of the second portion of the contents, and wherein the terminal device includes a unit which prepares a first portion of the contents, a unit which transmits the request of the second portion of the contents to the server, a unit which receives the encrypted second portion of the contents from the server, and obtains the second portion of the contents by decrypting the encrypted second portion of the contents, and a unit which restores the contents from the first and the second portions of the contents.

The unit which prepares the first portion of the contents may include a unit which transmits the request of the first portion of the contents to the server in response to input of a user, and a unit which receives the first portion of the contents from the server and stores the first portion.

The second portion of the contents may include information continuously needed in reproducing the contents.

In an embodiment, the contents may be moving picture contents, and the second portion of the contents may include a header information portion of moving picture data forming the moving picture contents.

In another embodiment, the contents may be the moving picture contents, and the second portion of the contents may include data corresponding to a specific portion in a story of the moving picture contents.

In still another embodiment, the contents may be programs, and the second portion of the contents may be data defining a function which is utilized in the programs.

The request of the second portion may be continuously transmitted when the contents are reproduced.

The request of the second portion may include at least a part of the first portion of the contents or specific information, and the server may perform certification of the request of the second portion and may transmit the second portion to the terminal device when the certification is correctly executed.

The certification may be determined based on coincidence of the first portion of the contents which the server transmitted to the terminal device in the past, with at least a part of the first portion included in the request of the second portion or the first portion specified by the specific information.

At least a part of the first portion included in the request of the second portion or the first portion specified by the specific information may be encrypted.

Key information utilized for the encryption may include time information of encryption of at least a part of the first portion or the specific information.

In an example, the server may transmit the identical second portions of the contents to a plurality of terminal devices. In another example, the server may transmit different second portions of the contents to a plurality of terminal devices.

The second portion may be formed by an identical common portion and an individual portion, and the server may transmit a combination of the common portion and individual portions different from each other to a plurality of terminal devices.

According to still another aspect of the present invention, there is provided a contents supplying method which is executed in a system including a server and a terminal device, including: a step which transmits a request of a first portion of contents in response to input of a user from the terminal device to the server; a step which transmits the first portion of the contents from the server to the terminal device in response to the request of the first portion of the contents; a step which receives the first portion of the contents from the server and stores the first portion in the terminal device; a step which transmits a request of the second portion of the contents to the server from the terminal device; a step which encrypts the second portion of the contents by a predetermined method in the server in response to the request of the second portion, and transmits an encrypted second portion of the contents to the terminal device; a step which receives the encrypted second portion of the contents from the server and obtains the second portion of the contents by decrypting the encrypted second portion of the contents, in the terminal device; and a step which restores the contents from the first and the second portions of the contents.

According to still another aspect of the present invention, there is provided a contents supplying method which is executed in a system including a server and a terminal device, including: a step which prepares a first portion of contents in the terminal device; a step which transmits a request of a second portion of the contents from the terminal device to the server; a step which encrypts the second portion of the contents by a predetermined method in response to the request of the second portion, and transmits an encrypted second portion of the contents from the server to the terminal device; a step which receives the encrypted second portion of the contents from the server and obtains the second portion of the contents by decrypting the encrypted second portion of the contents in the terminal device; and a step which restores the contents from the first and the second portions of the contents.

According to still another aspect of the present invention, there is provided a server of a contents supplying system including the server and a terminal device, wherein the terminal device includes a unit which transmits a request of a first portion of contents to the server in response to input of a user; a unit which receives the first portion of the contents from the server and stores the first portion; a unit which transmits a request of a second portion of the contents to the server; a unit which receives an encrypted second portion of the contents from the server and obtains the second portion of the contents by decrypting the encrypted second portion of the contents; and a unit which restores the contents from the first and the second portions of the contents, wherein the server includes: a unit which transmits the first portion of the contents to the terminal device in response to the request of the first portion of the contents; and a unit which encrypts the second portion of the contents by a predetermined method to transmit the encrypted second portion of the contents to the terminal device in response to the request of the second portion of the contents.

According to still another aspect of the present invention, there is provided a terminal device of a contents supplying system including a server and a terminal device: wherein the server includes a unit which transmits a first portion of contents to the terminal device in response to a request of the first portion of the contents, and a unit which encrypts a second portion of the contents by a predetermined method and transmits an encrypted second portion of the contents to the terminal device in response to a request of the second portion of the contents; and wherein the terminal device includes: a unit which transmits the request of the first portion of the contents to the server in response to input of a user; a unit which receives the first portion of the contents from the server and stores the first portion; a unit which transmits the request of the second portion of the contents to the server; a unit which receives the encrypted second portion of the contents from the server and obtains the second portion of the contents by decrypting the encrypted second portion of the contents; and a unit which restores the contents from the first and the second portions of the contents.

According to still another aspect of the present invention, there is provided a server of a contents supplying system including the server and a terminal device, wherein the terminal device includes a unit which prepares a first portion of contents; a unit which transmits a request of a second portion of the contents to the server; a unit which receives an encrypted second portion of the contents from the server and obtains the second portion of the contents by decrypting the encrypted second portion of the contents; and a unit which restores the contents from the first and the second portions of the contents, and wherein the server includes a unit which encrypts the second portion of the contents by a predetermined method and transmits the encrypted second portion of the contents to the terminal device in response to the request of the second portion of the contents.

According to still another aspect of the present invention, there is provided a terminal device of a contents supplying system including a server and the terminal device, wherein the server includes a unit which encrypts a second portion of contents by a predetermined method and transmits an encrypted second portion of the contents to the terminal in response to a request of the second portion of the contents, wherein the terminal device includes: a unit which prepares a first portion of the contents, a unit which transmits the request of the second portion of the contents to the server, a unit which receives the encrypted second portion of the contents from the server and obtains the second portion of the contents by decrypting the encrypted second portion of the contents, and a unit which restores the contents from the first and second portions of the contents.

According to still another aspect of the present invention, there is provided a contents supplying program which is executed in a server of a contents supplying system including the server and a terminal device, wherein the terminal device includes a unit which transmits a request of a first portion of contents to the server in response to input of a user, a unit which receives the first portion of the contents from the server and stores the first portion, a unit which transmits the request of the second portion of the contents to the server, a unit which receives an encrypted second portion of the contents from the server and obtains the second portion of the contents by decrypting the encrypted second portion of the contents, and a unit which restores the contents from the first and the second portions of the contents, wherein the program controls the server to function as: a unit which transmits the first portion of the contents to the terminal device in response to the request of the first portion of the contents, and a unit which encrypts the second portion of the contents by a predetermined method and transmits the encrypted second portion of the contents to the terminal device in response to the request of the second portion of the contents.

According to still another aspect of the present invention, there is provided a contents supplying program which is executed in a terminal device of a contents supplying system including a server and the terminal device, wherein the server includes a unit which transmits a first portion of the contents to the terminal device in response to a request of the first portion of the contents, a unit which encrypts the second portion of the contents by a predetermined method and transmits an encrypted second portion of the contents to the terminal device in response to a request of the second portion of the contents, and wherein the program controls the terminal device to function as: a unit which transmits the request of the first portion of the contents to the server in response to input of a user, a unit which receives the first portion of the contents from the server and stores the first portion, a unit which transmits the request of the second portion of the contents to the server, a unit which receives the encrypted second portion of the contents from the server and obtains the second portion of the contents by decrypting the encrypted second portion of the contents, and a unit which restores the contents from the first and the second portions of the contents.

According to still another aspect of the present invention, there is provided a contents supplying program which is executed in a server of a contents supplying system including the server and a terminal device, wherein the terminal device includes a unit which prepares a first portion of the contents, a unit which transmits a request of a second portion of the contents to the server, a unit which receives an encrypted second portion of the contents from the server and obtains the second portion of the contents by decrypting the encrypted second portion of the contents, a unit which restores the contents from the first and the second portions of the contents, and wherein the program controls the server to function as a unit which encrypts the second portion of the contents by a predetermined method and transmits the encrypted second portion of the contents to the terminal device.

According to still another aspect of the present invention, there is provided a contents supplying program which is executed in a terminal device of a contents supplying system including a server and the terminal device, wherein the server includes a unit which encrypts a second portion of the contents by a predetermined method and transmits an encrypted second portion of the contents to the terminal device in response to a request of the second portion of the contents, and wherein the program controls the terminal device to function as: a unit which prepares the first portion of the contents, a unit which transmits the request of the second portion of the contents to the server, a unit which receives the encrypted second portion of the contents from the server and obtains the second portion of the contents by decrypting the encrypted second portion of the contents, and a unit which restores the contents from the first and second portions of the contents.

The nature, utility, and further features of this invention will be more clearly apparent from the following detailed description with respect to preferred embodiment of the invention when read in conjunction with the accompanying drawings briefly described below.

### BRIEF DESCRIPTION OF THE DRAWINGS

FIGS. 1A and 1B schematically show a configuration of contents according to the embodiment of the present invention, and a basic contents supplying system.

FIG. 2 is a block diagram showing a configuration example of a contents supplying system according to the embodiment.

FIG. 3 is a block diagram showing another configuration example of a contents supplying system according to the embodiment.

FIGS. 4A and 4B are diagrams showing basic operations of a contents supplying system according to the embodiment.

FIG. 5 shows a configuration example for automatic generation of a core portion and a non-core portion of contents.

FIGS. 6A and 6B are diagrams illustrating methods of transmitting core portions.

FIGS. 7A and 7B are other diagrams illustrating methods of transmitting core portions.

FIGS. 8A and 8B are diagrams illustrating methods of transmitting contents.

FIG. 9 is a diagram showing a control system for supplying contents by a server.

### DETAILED DESCRIPTION OF THE PREFERRED EMBODIMENTS

The preferred embodiments of the present invention will now be described below with reference to the attached drawings. The present invention relates to a system for supplying contents to users by utilizing a communication channel and/or broadcasting. In the embodiment, the description is given of an example for supplying the contents from a server having the contents to a terminal device (client) of a user. It is prescribed that “contents” according to the present invention includes image and sound information of a movie, image information of a still picture, sound information of music, various kinds of programs and other data.

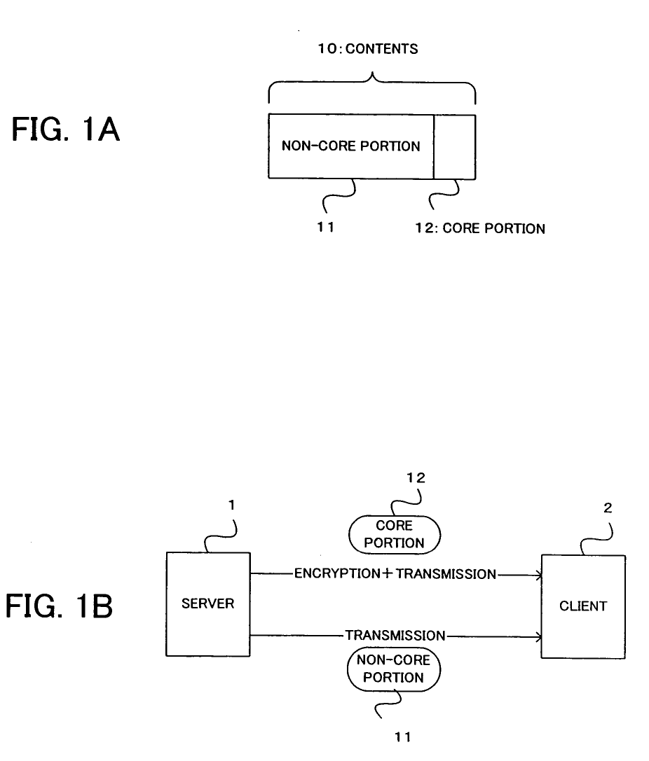

In the embodiment, it is a basic feature that the contents to be supplied to the user is divided into a core portion and anon-core portion, and a necessary encryption process is executed to the core portion before it is supplied to the client. FIG. 1A schematically shows a schematic configuration of the contents. As shown in FIG. 1A, contents 10 is divided into a core portion 12 and a portion 11 other than the core portion (hereafter, it is called “non-core portion”). Namely, by the core portion 12 and the non-core portion 11, the contents 10, such as a movie, is formed. It is preferred that the non-core portion 11 occupies most of the contents 10, and the core portion 12 has a certain small size. In the present invention, the core portion 12 serves as an significant portion in the contents 10, or as a continuously needed portion for reproducing and utilizing the contents 10 by the user.

FIG. 1B schematically shows a basic contents supplying method according to the embodiment. As shown in FIG. 1B, in the contents supplying system, a server 1 and a client 2 are provided in order to transmit information via a communication channel and the like.

The server 1 transmits, to the client 2, the contents 10 which is requested, in response to a request by the client 2. The contents 10 is formed by the core portion 12 and the non-core portion 11, as shown in FIG. 1A. On receiving the request of the contents 10 from the client 2, the server 1 transmits, to the client 2, the non-core portion 11, basically as it is, and the core portion 12 to which a predetermined encryption process has been executed.

The server 1 is a safe server having a certification function, and stores the core portion of the contents to be supplied to the client 2. The server 1 operates so that the core portion 12 is not written into a defenseless storing area of the client 2, in whatever the situation is.

Though the non-core portion 11 occupies most of the contents 10, the encryption process is not executed thereto. On the other hand, the core portion 12, whose data quantity is smaller than that of the non-core portion 11, is indispensable for reproducing and utilizing the contents 10. Therefore, the client 2 cannot substantially reproduce and utilize whole the contents 10 unless the client 2 obtains the encrypted core portion 12 and correctly decrypts it. Thus, in utilizing the contents 10 which seems to be stored in the clients 2 itself, the client 2 necessarily obtain the information of the lacked core portion 12 from the server 1.

According to the method, since the significant portion of the contents is determined as the core portion, which is to be encrypted and transmitted, it becomes possible that whole the contents are substantially protected by the encryption process of only the core portion. In this case, since only the core portion, which is merely a small part of the contents, is subjected to the encryption process, the load of the encryption process on the server side can be smaller than the load in encrypting whole the contents. Therefore, the load of the decryption process on the client side can also be smaller in reproducing and utilizing the contents. Even if the client is analyzed in some methods, it is impossible to extract a variable form of the contents from the client because the core portion is not stored in the client.

Concretely, according to the embodiment of the present invention, a contents supplying system includes a server and a terminal device. The server includes a unit which encrypts a second portion of contents by a predetermined method and transmits the encrypted second portion to the terminal device, in response to a request of the second portion of the contents. The terminal device has a unit which prepares a first portion of the contents, a unit which transmits the request of the second portion of the contents to the server, a unit which receives the encrypted second portion of the contents from the server, and obtains the second portion of the contents by decrypting the encrypted second portion, and a unit which restore the contents from the first and second portions.

According to the above-mentioned contents supplying system, the contents to be supplied to the user is formed by the first portion and the second portion. The user utilizes the terminal device, connects to the server and obtains the contents as the need arises, thereby to reproduce and utilize the contents. The terminal device can prepare the first portion of the contents in various methods. For example, the terminal device can request, to the server, the first portion of the contents designated by the user, and can receive the first portion from the server to prepare. Without the request from the terminal device, when the server regularly or irregularly transmits the first portion of the contents to certain or uncertain terminal devices, the terminal devices can prepare the first portion of the contents by receiving it from the server. One of this example is a case that the predetermined contents are transmitted by broadcasting service and the like. In another way, the first portion of the contents can be obtained from a storage medium and a storage device, other than the server. For example, when the terminal device has a storage unit for storing the first portion of the contents received from the server in the past, the client can prepare the first portion of the contents by simply reading out the first portion of the contents from the storage unit when it is needed. Moreover, when the first portion of the contents, which is provided or distributed, not via communication, but via the various storage mediums such as a CD-ROM and a DVD-ROM, the terminal device can also prepare the first portion of the contents by reading out the portion from such storage mediums.

Next, a preferred example of this invention will be explained with reference to the attached drawings.

[System Configuration]

(Basic Configuration)

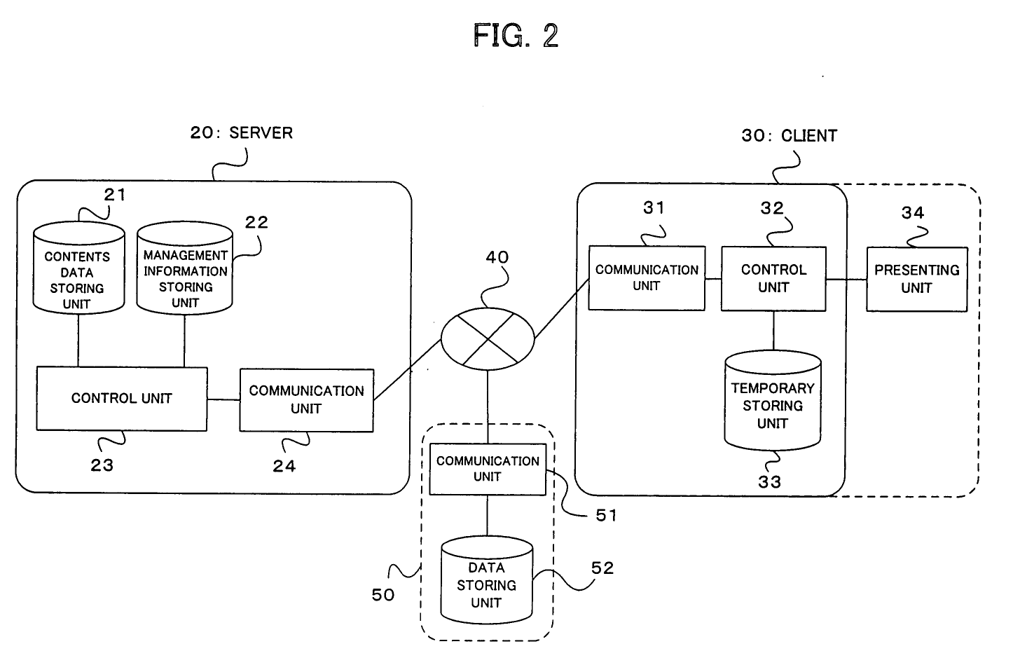

FIG. 2 shows a schematic configuration of the contents supplying system in the embodiment according to the present invention. As shown in FIG. 2, in the contents supplying system, a server 20 and a client 30 are connected to each other for communication via a communication channel 40. The communication channel 40 may be a network, such as the Internet. The server 20 possesses the contents to be supplied to the user, and transmits the contents to the client 30 as the need arises. On the other hand, the client 30 is the terminal device which the user uses.

As shown in FIG. 2, the server 20 includes a contents data storing unit 21, a management information storing unit 22, a control unit 23, and a communication unit 24. The contents data storing unit 21 is a database for storing data of the contents to be supplied to the user. For example, the contents data storing unit 21 stores data of a movie, music, a predetermined program and others as the contents.

The management information storing unit 22 is a database for storing management information for supplying the contents from the server 20 to the client 30. As the management information, various kinds of information relating to contents supply are included, e.g., which contents are transmitted to which user (client), when they are transmitted, how the data of the core portion and the non-core portion are determined, and the like. The communication unit 24 has a function of transmitting the contents and other information to the client 30 via the communication channel 40.

The control unit 23 executes necessary control for whole the contents supplying process from the server 20 to the client 30. Concretely, the control unit 23 executes various processes, e.g., processes for extracting, from the contents data storing unit 21, the contents which the client 30 requests, for determining the core portions and the non-core portions of the extracted contents, and for storing transmitting history information (log information) to the client 30.

On the other hand, the client 30 includes a communication unit 31, a control unit 32, a temporary storing unit 33, and a presenting unit 34 which is included as the need arises. The communication unit 31 communicates information with the server 20. The temporary storing unit 33 temporarily stores the contents supplied from the server 20, concretely the non-core portion 11. The presenting unit 34 presents an operational situation of the client and the contents to the user, and may include a display apparatus which displays image, a speaker which outputs sound, and the like. According to the kind of the client 30, the presenting unit 34 may be included inside the client 30 or may be provided separately and independently from the client 30.

The control unit 32 transmits necessary instruction and designation to the server 20 via the communication unit 31 and the channel 40, temporarily stores, in the temporary storing unit 33, the contents received from the server 20, and supplies the contents to the presenting unit 34 to reproduce. Also, when the portion of the contents is encrypted as the core portion and transmitted, the control unit 32 executes a process for decrypting the encrypted portion.

In the embodiment, the contents which the client requests is divided into the core portion 12 and the non-core portion 11 as shown in FIG. 1A, and the core portion 12 is supplied to the client 30 after being encrypted. On receiving the non-core portion 11, the client 30 can store the non-core portion 11 as it is in the temporary storing unit 33. On the other hand, the client 30 does not store the encrypted core portion 12 inside the client 30. Namely, whenever the core portion 12 is requested from the client 30 to the server 20, the core portion 12 is transmitted from the server 20 to the client 30. Every time the client 30 receives the core portion 12, the client 30 decrypts the encrypted core portion, and certifies the core portion as the need arises.

Time information of encryption may be included in key information utilized for the encryption of the core portion 12. Concretely, when the server 20 encrypts the core portion 12 in transmitting the core portion to the client 30, the time information of the encryption, indicating the time at which the server 30 encrypts the core portion 12, may be used as the key information. Also, when the server 20 encrypts the requested core portion 12 on receiving the request of the core portion 12 from the client 30, the time information indicating the time at which the client 30 requests the core portion 12 can be used as the key information.

There are several methods to prevent the core portion 12 transmitted from the server 20 from being stored in the temporary storing unit 33 inside the client 30. For example, a flag indicating “Do not store the data in the temporary storing unit 33 of the client” may be included in the core portion 12. The control unit 32 in the client 30 detects the flag and does not store the received core portion 12 in the temporary storing unit 33.

In another method, the server 20 combines a client ID with the information of the time at which the data of the core portion 12 is transmitted to the client, to generate the certification information. The client is designed such that the core portion can be obtained when the certification information is correct. In that case, the information of the core portion 12 can be stored in the temporary storing unit 33 in the client 30. However, since the certification information to release the encryption of the core portion 12 is always updated, the decryption of the core portion is impossible by the certification information which was stored in the temporary storing unit 33 in the past.

(Modification)

Next, the modification of the contents supplying system in the embodiment will be explained. As shown in FIG. 2 by a broken line, a buffer server 50 may be provided in addition to the server 20. In this case, the server 20 stores only the core portion 12 of each contents 10, and transmits the core portion 12 to each client 30. On the other hand, the buffer server 50 stores only the non-core portion 11 of each contents 10, and transmits the non-core portion 11 to each client 30. The buffer server 50 includes a data storing unit 52 which stores the data of the non-core portion 11 of the contents 10, and a communication unit 51 which communicates with the client 30 via the communication channel 40. It is noted that a plurality of buffer servers 50 may be provided in accordance with the number of the client 30 and the contents. Thereby, the loads of the server 20 in supplying the contents to a plurality of clients 30 can be reduced.

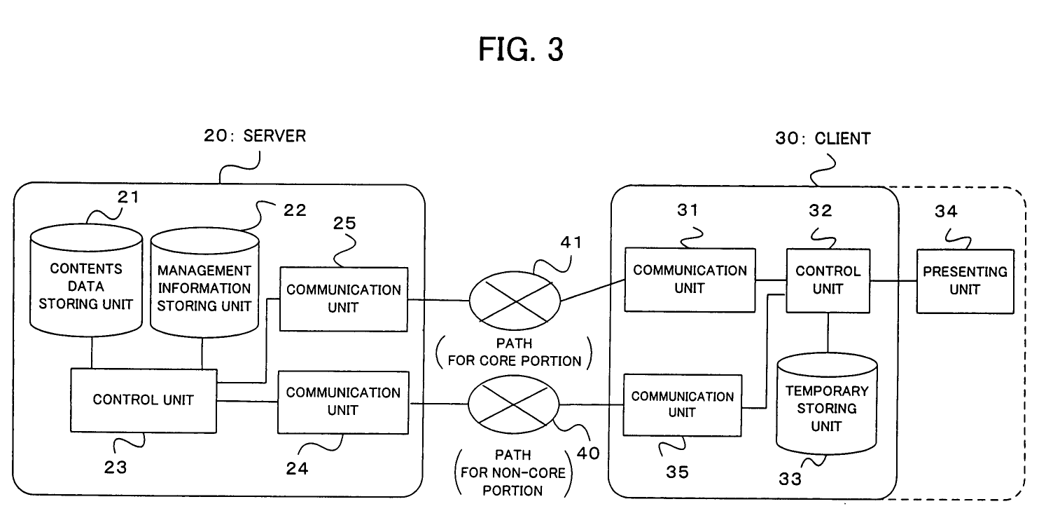

FIG. 3 shows another modification. In the modification shown in FIG. 3, a plurality of communication channels (paths) 40 and 41 are provided between the server 20 and the client 30. The communication channel 40 serves as the channel dedicated to the transmission of the non-core portion, and the channel 41 serves as the channel dedicated to the transmission of the core portion. Inside the server 20, separate communication units 24 and 25 are provided respectively corresponding to the two channels 40 and 41. Also, inside the client 30, separate communication units 35 and 31 are provided respectively corresponding to the two channels 40 and 41. Like this, if the communication channels dedicated to the transmission of the core portion and the non-core portion are separately provided, a third person, who tries to illegally receive the contents via the communication channel, cannot obtain both of the core portion and the non-core portion via a single channel. It is noted that examples of providing a plurality of communication channels include the user of different networks, the user of utilizing a network and a telephone line, and the like. Other than the method of physically separating the communication channels, the division of the communication channels in terms of time by utilizing the identical channel in different time, in terms of frequency, or in terms of space by varying a modulating system is possible.

[Operation of System]

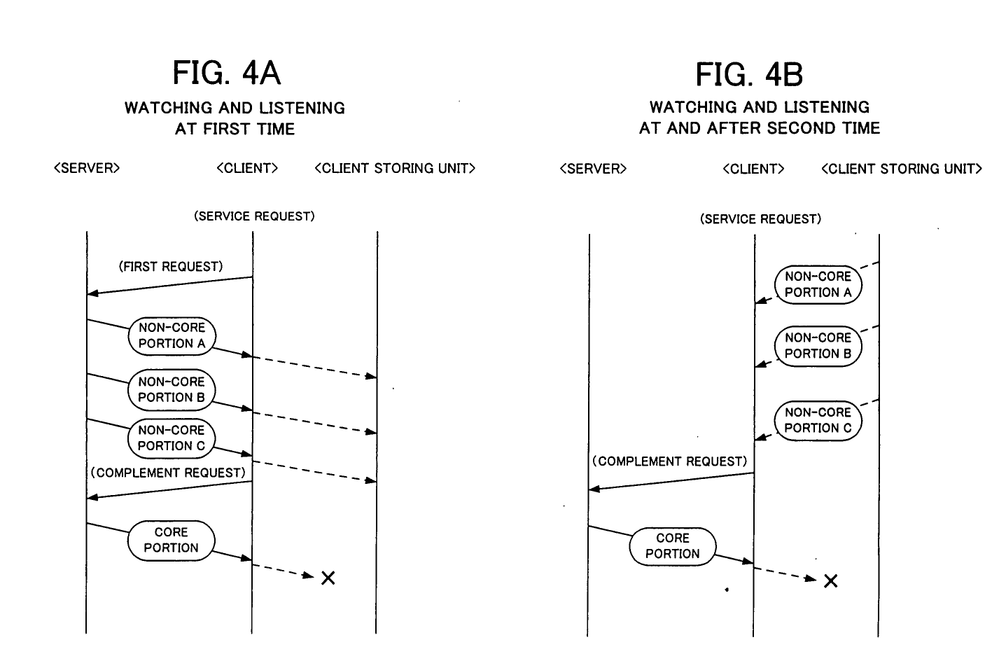

Next, the description will be given of an example about an operation of the above-mentioned contents supplying system. FIG. 4 is a diagram showing a process of supplying the contents from the server 20 to the client 30 by the system. In the example, the contents of a movie are supplied from the server 20 to the client 30. FIG. 4A is an example of a process in a case that the user watches and listens to the contents at the first time, and FIG. 4B is an example of a process in a case that the user repeatedly watches and listens to the identical contents at and after the second time. It is assumed that the contents are formed by three non-core portions A to C and one core portion in the example in FIG. 4.

First, at the first watching and listening, as shown in FIG. 4A, when the user wants the service of supplying of the contents, the user operates the client 30 and transmits, to the server 20, the first request for transmitting the contents. The server 20 transmits, in sequence, the three non-core portions A to C forming the contents to the client 30, in response to the first request. The client 30 receives, in sequence, the non-core portions A to C, and stores the non-core portions into the storing unit (e.g., the temporary storing unit 33 in FIG. 2) in the client 30.

When receiving the non-core portions A to C is completed, the client 30 transmits, to the server 20, a complement request which requests the core portion, which is lacked. The server 20 receives the complement request, and transmits the core portion to the client 30. The client 30 receives the core portion, decrypts the core portion by executing the necessary decryption process, and restores the contents formed by the non-core portions A to C and the core portion to reproduce and utilize. It is noted that the client 30 cannot store the core portion in the temporary storing unit 33, as explained above.

Next, watching and listening at and after the second time will be explained with reference to FIG. 4B. In watching and listening at and after the second time, when the user wants the service of supplying the contents, the user inputs the instruction thereof to the client 30. Thereby, the client 30 reads out, from the temporary storing unit 33, the non-core portions A to C which has already been stored by the watching and listening at the first time. However, since the core portion is not stored in the temporary storing unit 33 inside the client 30, the client 30 suitably transmits the complement request for the core portion to the server 20.

On receiving the complement request, the server 20 executes a predetermined encryption to the core portion, and transmits the encrypted core portion to the client 30. The client 30 decrypts the received core portion, and restores the contents from the non-core portions A to C and the core portion to reproduce. It is noted that the client 30 cannot store, in the temporary storing unit 33 inside the client, the core portion which is received from the server 20, in watching and listening at and after the second time, either.

Like this, by making it possible to store the non-core portion of the contents to be supplied to the user in the storing unit in the client, it is not necessary to transmit the non-core portion again in reproducing, watching and listening to the contents at and after the second time. Namely, it is not needed to repeatedly transmit the contents in vain because the non-core portion occupies most of the contents, as described above. On the other hand, since the core portion cannot be stored in the storing unit in the client, the core portion has to be received from the server and decrypted, whenever the watching and the listing are performed. Thereby, it becomes possible to prevent the illegal use of the contents. Since only the core portion whose data quantity is comparatively small, not whole the contents, is encrypted, the load of the certification process by the encryption of the core portion in the server and the decryption of the core portion in the client can be small.

The core portion may be formed so that the non-core portions are useless without the core portion, even though the non-core portions are stored in the client 30. Thereby, for example, it is possible that only the non-core portion in the contents is transmitted from the server 20 to the client 30 without the first request from the user, and the core portion is transmitted to the client 30 when the complement request of the core portion is made by the user. The method can realize such a contents supplying service that only the non-core portion of a pay contents is supplied free of charge to the client, and the core portion is transmitted with a charge, in response to the complement request from the user who is interested in the contents.

Though FIG. 4A shows the example in which the core portion is a single portion, the core portion may be suitably divided into plural portions in consideration of the speed and the unit of the communication and a unit of the data. Also, the core portion may be divided into core portions A to C corresponding to the non-core portions, for example.

(Determination of Core Portion)

Next, the determination of the core portion will be explained. In the system, the important thing is how the core portion, a significant portion of the contents, is determined. In the embodiment, basically, the core portion is a core of substantial value of the contents, such as a specific portion of an MPEG (Moving Picture Experts Group) stream, a header portion, or a main portion of a program. At the same time, the core portion is determined such that it is impossible to guess and form the core portion from the non-core portion. As described above, the core portion has a data size capable of being certified comparatively in a short time when the client utilizes the contents.

More concretely, in a case of moving image contents of the MPEG, by setting an I-picture as the core portion, the image from the I-picture to the next I-picture cannot be reformed without the core portion. In a case of contents having a story, such as a movie and a drama, by setting the significant portion in the story, like “the significant scene” and “the final episode”, as the core portion, it is possible that the value of whole the story remarkably goes down without the core portion. By taking account of the time information in such contents, the portion which generally plays an significant part in the story, for example, the last thirty-minute scene of the movie, can be used as the core portion.

In the contents of the movie and a TV program, when contents data and TV program data relating to the contents exist, the core portion can be determined based on the data. For example, when climax information indicating the significant portion in the story is included in contents data of the movie and the TV program data of the TV program, the portion which the information indicates can be set to the core portion. Moreover, in a case that the contents are the predetermined program, the main portion or certain constants indispensable for executing the program can be set to the core portions.

As described above, basically, the core portion is determined factiously in advance for each contents. After that determination, a process for extracting the core portion is automatic. For example, as described above, after factitiously determining the I-picture or the last thirty-minute movie as the core portion, the server 30 executes the predetermined program, and the I-picture or the last thirty-minute contents data of the movie contents are automatically extracted in the contents data, so that the extracted data is used as the core portion 12. As another example, in a case of the moving picture contents such as a movie, it is possible that scene change and the significant scene are automatically detected from the contents data, based on information of the picture motion and various header information in the contents data, thereby to set the portion or the scene as the core portion.

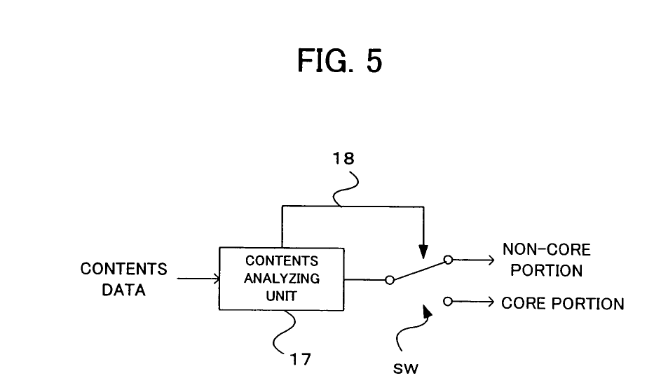

Concretely, as shown in FIG. 5, a contents analyzing unit 17 may be included in the server 20. On receiving input of the contents data, the contents analyzing unit 17 determines the core portion, based on the above-mentioned header information or the information of the picture motion, to generate a switching signal 18. The switching signal 18 distinguishes the core portion and the non-core portion. Based on the switching signal 18, it becomes possible that a switch SW is controlled, and the contents data outputted from the contents analyzing unit 17 is divided into the core portion and the non-core portion to be output.

It is noted that the contents in the present invention include not only the image and the sound information, but also the information or data like a program, as understood in the above explanation.

(Process of Core Portion)

Next, various processes applied to the core portion will be explained. It is noted that an example as follows is in a case that the core portion in the identical contents is transmitted from the server 20 to the plurality of clients 30.

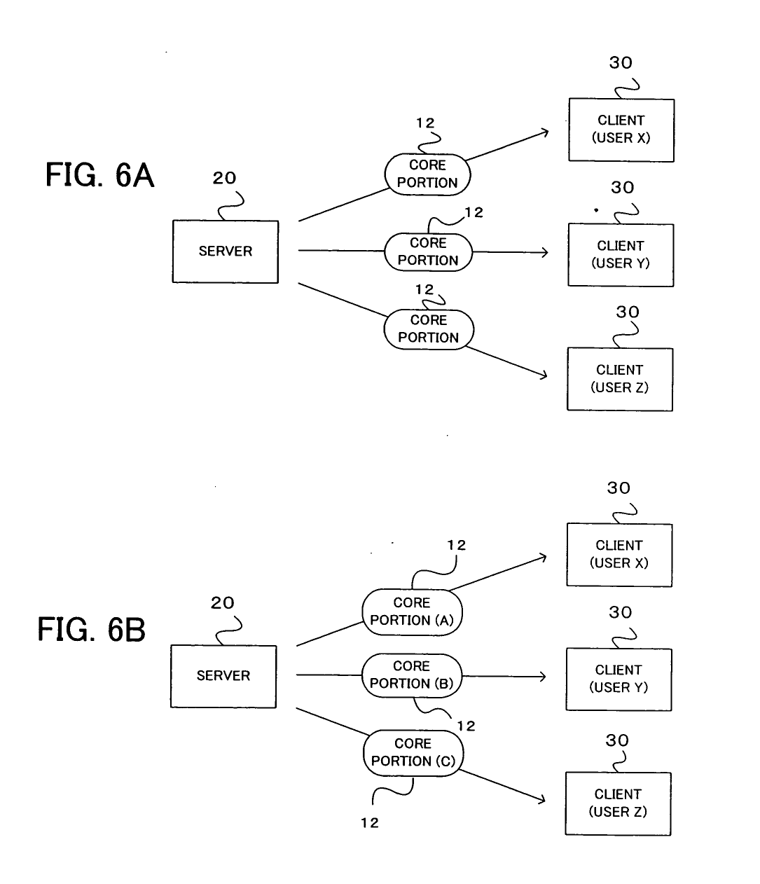

FIG. 6A shows a basic configuration, wherein the core portion 12 is transmitted from the server 20 to the plurality of clients 30. The server 20 transmits the identical core portion 12 to each client 30. In this method, each client 30 obtains the identical core portion 12 by decrypting the encrypted core portion 12. Thereby, it can be prevented that the users of the plurality of clients complement, in conspiracy, the lacked core portion with each other. Namely, when the core portions for the plurality of clients are different, if each user decrypts each core portion to exchange the core portion with each other, whole the contents can be obtained. Therefore, by using the identical core portion transmitted to all the clients, such a problem can be overcome.

On the other hand, FIG. 6B shows a method of transmitting different core portions 12 from the server 20 to the plurality of clients 30. In this case, the core portions obtained by the decryption in each client 30 are different from each other. Thus, for example, when a certain core portion is illegally copied and distributed, the user who performs such an illegal action can be found out by specifying the core portion. For example, in the example in FIG. 6B, when the core portion B is illegally copied and distributed, it can be guessed that the action is performed by the user Y.

More concretely, this can be realized by storing information as to “which core portion is transmitted to which client (user)” in the control information storing unit 22 in the server 20. In another method, this can be also realized by transmitting the core portion including each user ID and client ID. Instead of the client ID, it is possible to include electronic watermark being different dependently on each user.

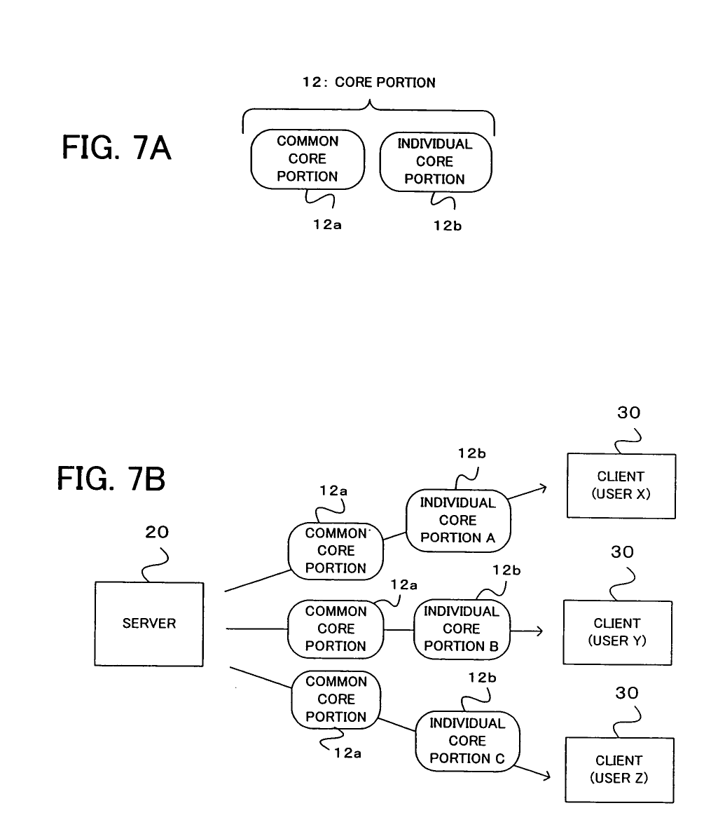

Next, the description will be given of a method of forming the core portion by the plurality of portions. In the above-mentioned examples, basically, the core portion is one. On the other hand, as shown in FIG. 7A, the core portion 12 may be formed by a common core portion 12a and an individual core portion 12b. As shown in FIG. 7B, a combination of the common core portion and the individual core portion being different from each other is transmitted to each client. Thereby, like in the case in FIG. 6A, it can be prevented that the plurality of clients complement, in conspiracy, the contents with each other by the common core portion. At the same time, by specifying the user who transmitted the core portion illegally copied, like in the case in FIG. 6B, the main user who performed the illegal action can be specified.

(Control by Server)

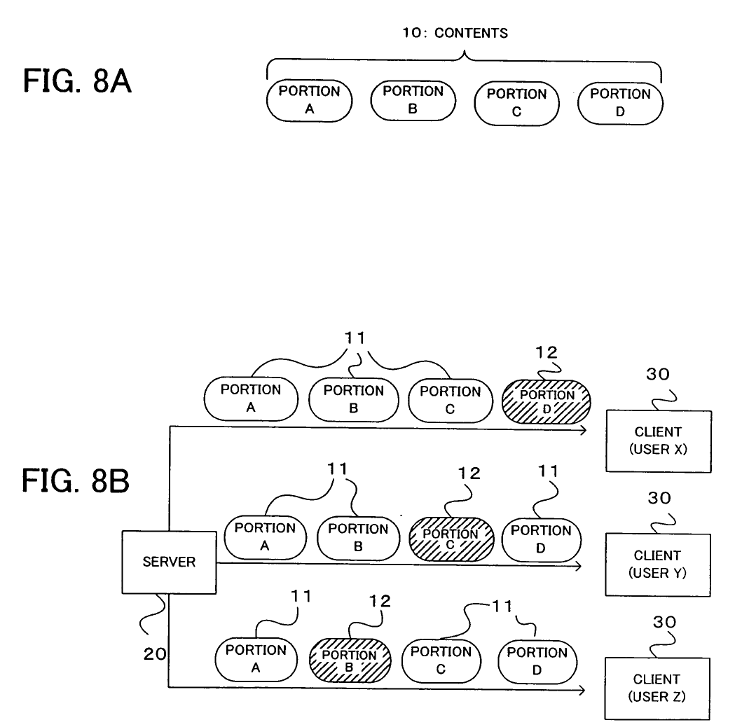

Next, the management of the core portion by the server will be explained with reference to FIGS. 8A and 8B. In the case in FIG. 6B, by transmitting different core portion to each client, the main user of the illegal action can be specified. FIGS. 8A and 8B show a concrete example thereof. In this example, as shown in FIG. 8A, the contents 10 are formed by four portions A to D. The server 20 transmits, to a client 30 of a user X, the portions A to C as the non-core portion 11, and the portion D as the core portion 12. The server 20 transmits, to a client 30 of a user Y, the portions A, B and D as the non-core portion 11, and the portion C as the core portion 12. Similarly, the server 20 transmits, to a client 30 of a user Z, the portions A, C and D as the non-core portion 11, and the portion B as the core portion 12. At the same time, the server 20 stores, in the management information storing unit 22, which portion among A to Dare set to the core portion for each user X to Z. Thereby, the server 20 can always grasp which core portion is transmitted to which client (user).

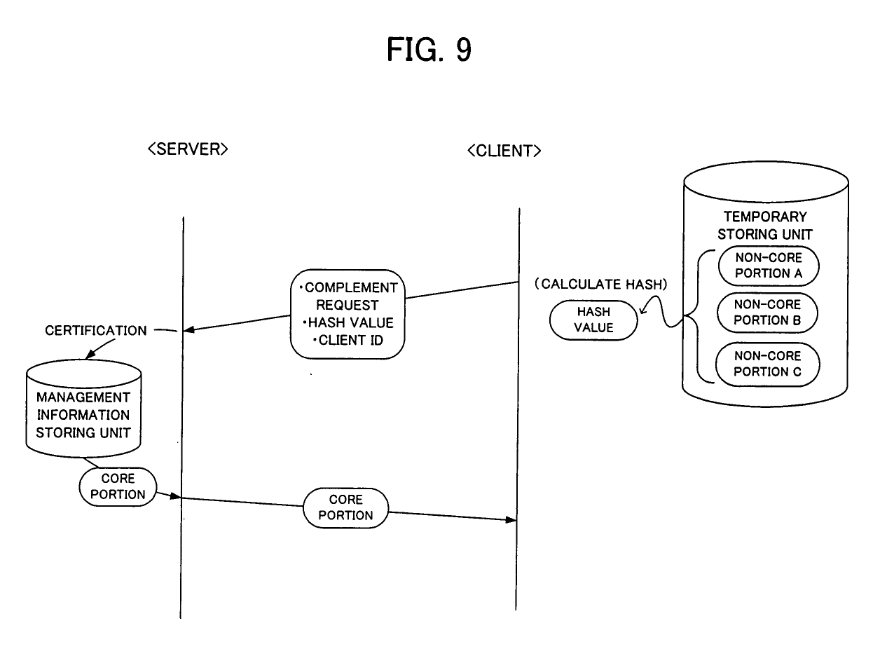

Next, the description will be given of another method of managing the core portion by the server, with reference to FIG. 9. In the example in FIG. 8, it is stored in the server 20 which portion of the contents is transmitted to which client as the core portion. In an example in FIG. 9, by including, in the complement request by the client, the information specifying the non-core portion which has been already transmitted to the client, the core portion to be transmitted from the server 20 to the client 30 is specified. It is assumed that the contents transmitted in FIG. 9 has the configuration identical to the configuration shown in FIG. 8A.

As shown in FIG. 9, it is assumed that the portions A to C have been already transmitted to the client 30, as the non-core portion. At that time, the client 30 transmits, to the server 20, the complement request including the certification information, such as specific information for specifying the non-core portion, e.g., a hash value (a value calculated by a hash function) which is extracted or calculated from the non-core portions A to C in the client 30. The server 20 receives the complement request, and certifies the client transmitting the complement request by referring the hash value as the certification process, to recognize that the client has the non-core portions A to C. The server 20 then determines the lacked portion D as the core portion, and executes the predetermined encryption to transmit the portion D thus encrypted to the client. Thereby, the server 20 executes the certification of the complement request, based on the hash value in the complement request which is received from the client 30, and determines the core portion to transmit.

The client 30 can encrypt the specific information of the non-core portion, such as the above-mentioned hash value, and transmit the information to the server 20. At that time, the key information of the encryption may be the time information indicating the time at which the client 30 encrypts the specific information.

In the above example, the certification process is executed by the specific information of the non-core portion, such as the hash value. Instead, the non-core portion itself or a portion thereof may be utilized as the certification information.

Though the above-mentioned explanation is of the example of the complement request from the client, the identical method may be applied not only to the complement request, but also to a receiving confirmation (acknowledgement) of the non-core portion transmitted from the server 20 to the client 30. Namely, not when the client 30 performs the complement request, but when the non-core portion 11 is received from the server 20, the above-mentioned method may be utilized for notifying the server 20 that the non-core portion 11 transmitted from the server 20 is received by the client 30. For example, when a certain client 30 receives the non-core portions A to C, the value extracted or calculated from those non-core portions A to C, i.e., the hash value and the like, is transmitted to the server 20, as receiving confirmation information, soon or at a predetermined timing. By receiving and referring the hash value, the server 20 can confirm that the non-core portions A to C requested from the client 30 are certainly received by the client 30.

Every time the server 20 transmits the core portion to the client 30, the server 20 may store the transmitting history as the log information, and further, the server 20 can transmit the log information to the client 30. In this case, the client 30 includes, to the complement request, the log information as the certification information, instead of the hash value, (e.g., the log information indicating that the non-core portions A to C are received from the server 20 at certain time on a certain day) to transmit the complement request to the server 20. The server 20 executes the certification of the client who transmits the log information by receiving and analyzing the log information, and can determine to transmit, to the client, the portion D as the core portion.

Such log information may be utilized for detecting illegal actions which can happen to the client 30. For example, the server 20 regularly accesses the client 30, and obtains the log information about the contents transmitted in the past, thereby to compare the log information thus obtained from the client 30 with the log information stored in the server 20. If those log information are not identical, the server 20 can determine that some changes happen to the client 30. The timing at which the log information in the client 30 is obtained and compared may be the time at which the complement request is performed from the client 30 to the server 20, besides regularly set timings.

The invention may be embodied on other specific forms without departing from the spirit or essential characteristics thereof. The present embodiments therefore to be considered in all respects as illustrative and not restrictive, the scope of the invention being indicated by the appended claims rather than by the foregoing description and all changes which come within the meaning an range of equivalency of the claims are therefore intended to embraced therein.

The entire disclosure of Japanese Patent Application No. 2003-82810 filed on Mar. 25, 2003 including the specification, claims, drawings and summary is incorporated herein by reference in its entirety.

What is claimed is:

1. A contents supplying system comprising a server and a terminal device,
wherein the server comprises:
a unit which encrypts a second portion of contents by a predetermined method and transmits an encrypted second portion of the contents to the terminal device in response to a request of the second portion of the contents, and
wherein the terminal device comprises:
a unit which prepares a first portion of the contents;
a unit which transmits the request of the second portion of the contents to the server;
a unit which receives the encrypted second portion of the contents from the server, and obtains the second portion of the contents by decrypting the encrypted second portion of the contents; and
a unit which restores the contents from the first and the second portions of the contents.

2. The contents supplying system according to claim 1,
wherein the unit which prepares the first portion of the contents comprises:
a unit which transmits the request of the first portion of the contents to the server in response to input of a user; and
a unit which receives the first portion of the contents from the server and stores the first portion.

3. The contents supplying system according to claim 1, wherein the second portion of the contents comprises information continuously needed in reproducing the contents.

4. The contents supplying system according to claim 3, wherein the contents are moving picture contents, and wherein the second portion of the contents comprises a header information portion of moving picture data forming the moving picture contents.

5. The contents supplying system according to claim 3, wherein the contents are the moving picture contents, and wherein the second portion of the contents comprises data corresponding to a specific portion in a story of the moving picture contents.

6. The contents supplying system according to claim 3, wherein the contents are programs, and wherein the second portion of the contents is data defining a function which is utilized in the programs.

7. The contents supplying system according to claim 1, wherein the request of the second portion is continuously transmitted when the contents are reproduced.

8. The contents supplying system according to claim 1, wherein the request of the second portion comprises at least a part of the first portion of the contents or specific information, and wherein the server performs certification of the request of the second portion and transmits the second portion to the terminal device when the certification is correctly executed.

9. The contents supplying system according to claim 8, wherein the certification is determined based on coincidence of the first portion of the contents which the server transmitted to the terminal device in the past, with at least a part of the first portion included in the request of the second portion or the first portion specified by the specific information.

10. The contents supplying system according to claim 9, wherein at least a part of the first portion included in the request of the second portion or the first portion specified by the specific information is encrypted.

11. The contents supplying system according to claim 10, wherein key information utilized for the encryption comprises time information of encryption of at least a part of the first portion or the specific information.

12. The contents supplying system according to claim 1, wherein the server transmits the identical second portions of the contents to a plurality of terminal devices.

13. The contents supplying system according to claim 1, wherein the server transmits different second portions of the contents to a plurality of terminal devices respectively.

14. The contents supplying system according to claim 1, wherein the second portion is formed by an identical common portion and an individual portion, and wherein the server transmits a combination of the common portion and individual portions different from each other to a plurality of terminal devices.

15. A contents supplying method which is executed in a system comprising a server and a terminal device, comprising:
a step which transmits a request of a first portion of contents in response to input of a user from the terminal device to the server;
a step which transmits the first portion of the contents from the server to the terminal device in response to the request of the first portion of the contents;
a step which receives the first portion of the contents from the server and stores the first portion in the terminal device;
a step which transmits a request of the second portion of the contents to the server from the terminal device;
a step which encrypts the second portion of the contents by a predetermined method in the server in response to the request of the second portion, and transmits an encrypted second portion of the contents to the terminal device;
a step which receives the encrypted second portion of the contents from the server and obtains the second portion of the contents by decrypting the encrypted second portion of the contents, in the terminal device; and
a step which restores the contents from the first and the second portions of the contents.

16. A contents supplying method which is executed in a system comprising a server and a terminal device, comprising:
a step which prepares a first portion of contents in the terminal device;
a step which transmits a request of a second portion of the contents from the terminal device to the server;
a step which encrypts the second portion of the contents by a predetermined method in response to the request of the second portion, and transmits an encrypted second portion of the contents from the server to the terminal device;
a step which receives the encrypted second portion of the contents from the server and obtains the second portion of the contents by decrypting the encrypted second portion of the contents in the terminal device; and
a step which restores the contents from the first and the second portions of the contents.

17. A server of a contents supplying system comprising the server and a terminal device, wherein the terminal device comprises a unit which transmits a request of a first portion of contents to the server in response to input of a user; a unit which receives the first portion of the contents from the server and stores the first portion; a unit which transmits a request of a second portion of the contents to the server; a unit which receives an encrypted second portion of the contents from the server and obtains the second portion of the contents by decrypting the encrypted second portion of the contents; and a unit which restores the contents from the first and the second portions of the contents,
wherein the server comprises:
a unit which transmits the first portion of the contents to the terminal device in response to the request of the first portion of the contents; and
a unit which encrypts the second portion of the contents by a predetermined method to transmit the encrypted second portion of the contents to the terminal device in response to the request of the second portion of the contents.

18. A terminal device of a contents supplying system comprising a server and a terminal device:
wherein the server includes a unit which transmits a first portion of contents to the terminal device in response to a request of the first portion of the contents, and a unit which encrypts a second portion of the contents by a predetermined method and transmits an encrypted second portion of the contents to the terminal device in response to a request of the second portion of the contents; and
wherein the terminal device comprises:
a unit which transmits the request of the first portion of the contents to the server in response to input of a user;
a unit which receives the first portion of the contents from the server and stores the first portion;
a unit which transmits the request of the second portion of the contents to the server;
a unit which receives the encrypted second portion of the contents from the server and obtains the second portion of the contents by decrypting the encrypted second portion of the contents; and
a unit which restores the contents from the first and the second portions of the contents.

19. A server of a contents supplying system comprising the server and a terminal device, wherein the terminal device includes a unit which prepares a first portion of contents; a unit which transmits a request of a second portion of the contents to the server; a unit which receives an encrypted second portion of the contents from the server and obtains the second portion of the contents by decrypting the encrypted second portion of the contents; and a unit which restores the contents from the first and the second portions of the contents, and
wherein the server comprises a unit which encrypts the second portion of the contents by a predetermined method and transmits the encrypted second portion of the contents to the terminal device in response to the request of the second portion of the contents.

20. A terminal device of a contents supplying system comprising a server and the terminal device, wherein the server comprises a unit which encrypts a second portion of contents by a predetermined method and transmits an encrypted second portion of the contents to the terminal in response to a request of the second portion of the contents,
wherein the terminal device comprises:
a unit which prepares a first portion of the contents,
a unit which transmits the request of the second portion of the contents to the server,
a unit which receives the encrypted second portion of the contents from the server and obtains the second portion of the contents by decrypting the encrypted second portion of the contents, and
a unit which restores the contents from the first and second portions of the contents.

21. A contents supplying program which is executed in a server of a contents supplying system comprising the server and a terminal device, wherein the terminal device includes a unit which transmits a request of a first portion of contents to the server in response to input of a user, a unit which receives the first portion of the contents from the server and stores the first portion, a unit which transmits the request of the second portion of the contents to the server, a unit which receives an encrypted second portion of the contents from the server and obtains the second portion of the contents by decrypting the encrypted second portion of the contents, and a unit which restores the contents from the first and the second portions of the contents,
wherein the program controls the server to function as:
a unit which transmits the first portion of the contents to the terminal device in response to the request of the first portion of the contents, and
a unit which encrypts the second portion of the contents by a predetermined method and transmits the encrypted second portion of the contents to the terminal device in response to the request of the second portion of the contents.

22. A contents supplying program which is executed in a terminal device of a contents supplying system comprising a server and the terminal device, wherein the server comprises a unit which transmits a first portion of the contents to the terminal device in response to a request of the first portion of the contents, a unit which encrypts the second portion of the contents by a predetermined method and transmits an encrypted second portion of the contents to the terminal device in response to a request of the second portion of the contents, and
wherein the program controls the terminal device to function as:
a unit which transmits the request of the first portion of the contents to the server in response to input of a user,
a unit which receives the first portion of the contents from the server and stores the first portion,
a unit which transmits the request of the second portion of the contents to the server,
a unit which receives the encrypted second portion of the contents from the server and obtains the second portion of the contents by decrypting the encrypted second portion of the contents, and
a unit which restores the contents from the first and the second portions of the contents.

23. A contents supplying program which is executed in a server of a contents supplying system comprising the server and a terminal device, wherein the terminal device includes a unit which prepares a first portion of the contents, a unit which transmits a request of a second portion of the contents to the server, a unit which receives an encrypted second portion of the contents from the server and obtains the second portion of the contents by decrypting the encrypted second portion of the contents, a unit which restores the contents from the first and the second portions of the contents, and
wherein the program controls the server to function as a unit which encrypts the second portion of the contents by a predetermined method and transmits the encrypted second portion of the contents to the terminal device.

24. A contents supplying program which is executed in a terminal device of a contents supplying system comprising a server and the terminal device, wherein the server comprises a unit which encrypts a second portion of the contents by a predetermined method and transmits an encrypted second portion of the contents to the terminal device in response to a request of the second portion of the contents, and
wherein the program controls the terminal device to function as:
a unit which prepares the first portion of the contents,
a unit which transmits the request of the second portion of the contents to the server,
a unit which receives the encrypted second portion of the contents from the server and obtains the second portion of the contents by decrypting the encrypted second portion of the contents, and
a unit which restores the contents from the first and second portions of the contents.
